(19) United States
(12) Patent Application Publication
(10) Pub. No.: US 2024/0243568 A1
(43) Pub. Date: Jul. 18, 2024

(54) VOLTAGE CONTROL SYSTEM

(71) Applicant: SENAO NETWORKS, INC., Taipei (TW)

(72) Inventor: Pi-Kung KU, Taipei (TW)

(21) Appl. No.: 18/404,051

(22) Filed: Jan. 4, 2024

(30) Foreign Application Priority Data
Jan. 17, 2023 (TW) 112102119

(51) Int. Cl. H02H 9/00; H02H 3/087; H02H 3/20; H02H 9/02

(52) U.S. Cl. CPC H02H 9/002; H02H 3/087; H02H 3/202; H02H 9/025

(57) ABSTRACT

A voltage control system includes a load device and a power supply device. The load device is configured to generate a current signal according to a voltage signal. The power supply device is configured to provide the voltage signal to the load device. The power supply device is further configured to adjust the voltage signal in response to an inrush current of the current signal, and stop adjusting the voltage signal in response to a pulse current of the current signal. The inrush current and the pulse current are arranged in order.

### CROSS-REFERENCE TO RELATED APPLICATIONS

This non-provisional application claims priority under 35 U.S.C. § 119(a) on Patent Application No(s). 112102119 filed in Taiwan on Jan. 17, 2023, the entire contents of which are hereby incorporated by reference.

### BACKGROUND OF THE INVENTION

The present disclosure relates to a voltage control technology. More particularly, the present disclosure relates to a voltage control system.

For the power supply end to provide an ideal voltage to the equipment end, it is necessary to deploy a communication chip on both the power supply end and the equipment end, so that the power supply end and the equipment end are able to communicate with each other. This way, however, leads to a higher cost. In addition, a dedicated power and dedicated signal transmission lines are also necessary for the communication chip, which is not conducive to industrial product use. Thus, there is an urgent need in the art to solve the above-mentioned problems.

### SUMMARY OF INVENTION

The present disclosure provides a voltage control system. The voltage control system may comprise a load device and a power supply device. The load device may be configured to generate a current signal according to a voltage signal. The power supply device may be configured to provide the voltage signal to the load device. The power supply device may further be configured to start to adjust the voltage signal in response to an inrush current of the current signal, and stop adjusting the voltage signal in response to a pulse current of the current signal. The inrush current and the pulse current may be arranged in order.

### DESCRIPTION OF DRAWINGS

FIG. 1 is a schematic diagram illustrating a voltage control system according to one or more embodiments of the present disclosure.

FIG. 2 is a timing diagram illustrating an operation of the voltage control system shown in FIG. 1 according to one or more embodiments of the present disclosure.

FIG. 3 is a timing diagram illustrating another operation of the voltage control system shown in FIG. 1 according to one or more embodiments of the present disclosure.

FIG. 4 is a timing diagram illustrating another operation of the voltage control system shown in FIG. 1 according to one or more embodiments of the present disclosure.

FIG. 5 is a timing diagram illustrating another operation of the voltage control system shown in FIG. 1 according to one or more embodiments of the present disclosure.

FIG. 6 is a schematic diagram illustrating a voltage control system according to one or more embodiments of the present disclosure.

FIG. 7 is a timing diagram illustrating an operation of the voltage control system shown in FIG. 6 according to one or more embodiments of the present disclosure.

FIG. 8 is a schematic diagram illustrating a voltage control system according to one or more embodiments of the present disclosure.

### DETAILED DESCRIPTION OF PREFERRED EMBODIMENTS

When an element is referred to as “being connected to” or “being coupled with” herein, it may mean “being electrically connected to” or “being electrically coupled with”. “Being connected to” or “being coupled with” may also be used to indicate that two or more elements cooperate or interact with each other. In addition, although the terms such as “first”, “second”, etc. used herein describe different elements, these terms are only used to distinguish elements or operations described with the same technical terms. Unless the context clearly indicates, the terms neither specifically refer to or imply an order or sequence, nor intend to limit the present disclosure.

Unless otherwise defined, all terms (including technical and scientific terms) used herein have the same meaning as commonly understood by one of ordinary skilled in the art. It will be further understood that terms such as those defined in commonly used dictionaries should be interpreted to have meanings consistent with their meanings in the relevant art and in the context of the present disclosure, and will not be interpreted as idealized or overly formal unless otherwise expressly defined herein.

The terminology used herein is only for the purpose of describing particular embodiments and is not intended to be limiting. As used herein, the singular forms “a”, “an”, “one” and “the” are intended to comprise plural forms including “at least one” unless the content clearly indicates. “Or” means “and/or”. As used herein, the term “and/or” comprises any and all combinations of one or more of the associated listed items. It should also be understood that when used in this specification, the terms “comprise” and/or “comprise” specify the features, regions, integers, steps, operations, presence of elements and/or parts, but does not exclude the existence or addition of one or more other features, regions, integers, steps, operations, elements, parts and/or combinations thereof.

The following will disclose multiple embodiments of the present disclosure with drawings, and for clarity, many practical details will be described together in the following description. However, it should be understood that these practical details should not be used to limit the present disclosure. That is, in some embodiments of the present disclosure, these practical details are unnecessary. In addition, for simplifying the drawings, some well-known and commonly used structures and elements will be shown in a simple and schematic manner in the drawings.

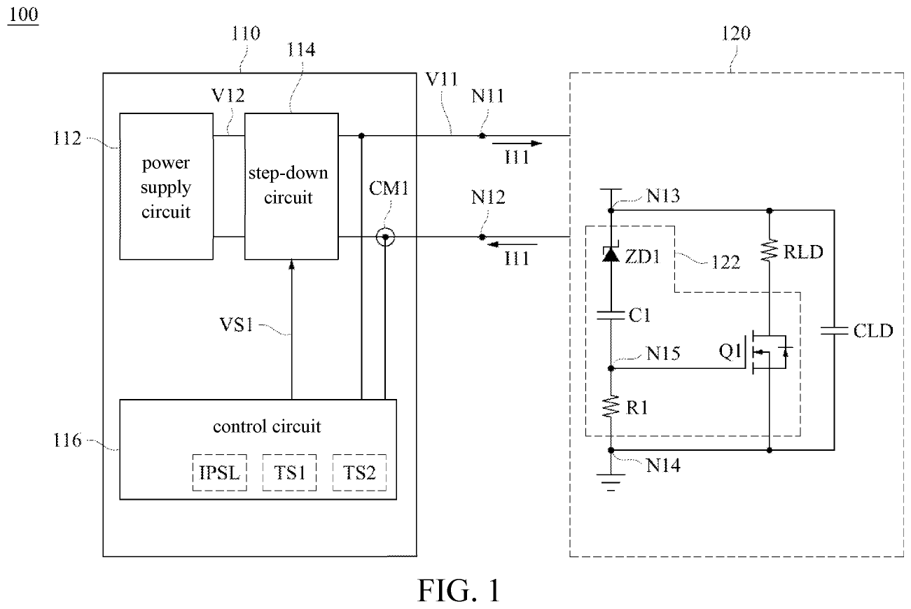

FIG. 1 is a schematic diagram of a voltage control system 100 according to an embodiment of the present disclosure. As shown in FIG. 1, the voltage control system 100 comprises a power supply device 110 and a load device 120. The power supply device 110 may be configured to provide a voltage signal V11 to the node N11 in order to charge the load device 120. The load device 120 may be configured to generate the current signal I11 according to the voltage signal V11, and the current signal I11 may flow to the power supply device 110 through the node N12, so that the power supply device 110 may adjust the voltage signal V11 according to the current signal I11.

In some embodiments, the current signal I11 may flow from the power supply device 110 to the load device 120 through the node N11, and may flow from the load device 120 to the power supply device 110 through the node N12. In some embodiments, the power supply device 110 may be referred to as a power supply end, and the load device 120 may be referred to as an equipment end.

As shown in FIG. 1, the power supply device 110 may comprise a power supply circuit 112, a step-down circuit 114, and a control circuit 116. The power supply circuit 112 may provide the voltage signal V12 to the step-down circuit 114. The step-down circuit 114 may generate the voltage signal V11 at the node N11 according to the voltage signal V12. The control circuit 116 may generate a control signal VS1 according to the voltage signal V11 and the current signal I11, and may provide the control signal VS1 to the step-down circuit 114, so that the step-down circuit 114 adjusts the voltage signal V11 according to the control signal VS1. In some embodiments, the control circuit 116 measures the current level of the current signal I11 through the current measuring device CM1 coupled with the node N12.

In some embodiments, the control circuit 116 may store a predetermined current level IPSL and predetermined durations of time TS1 and TS2, compare the predetermined current level IPSL and the predetermined durations of time TS1 and TS2 with the characteristics of the current signal I11, and generate the control signal VS1 according to the comparison result.

In some embodiments, the voltage signal V12 is a DC voltage signal of around 125 volts, and the voltage signal V11 is a DC voltage signal of around 12 to 125 volts with a power of 60 watts. In some embodiments, the step-down circuit 114 may be implemented by a high voltage buck device. The control circuit 116 may be implemented by a micro controller unit (MCU).

As shown in FIG. 1, the load device 120 may comprise a voltage detection circuit 122, a load resistor RLD, and a load capacitor CLD. The voltage detection circuit 122 may be coupled with each of the first end of the load resistor RLD and the first end of the load capacitor CLD at the node N13, and may be coupled with the second end of the load capacitor CLD at the node N14. In some embodiments, the node N14 may have a ground voltage level.

In some embodiments, when the load device 120 is coupled with (e.g., being plugged into) the power supply device 110, the node N11 may be coupled with the node N13, and the node N12 may be coupled with the node N14, so that the load device 120 may generate a current signal I11 flowing through the node N14 according to the voltage signal V11 transmitted to the node N13.

As shown in FIG. 1, the voltage detection circuit 122 may comprise a voltage stabilizing element ZD1, a capacitor C1, a resistor R1, and a switch Q1. The first end of the voltage stabilizing element ZD1 may be coupled with the node N13, and the second end of the voltage stabilizing element ZD1 may be coupled with the first end of the capacitor C1. Each of the second end of the capacitor C1, the first end of the resistor R1 and the control end of the switch Q1 may be coupled with the node N15. The second end of the resistor R1 may be coupled with the node N14. The first end of the switch Q1 may be coupled with the second end of the load resistor RLD, and the second end of the switch Q1 may be coupled with the node N14.

In some embodiments, the voltage stabilizing element ZD1 is turned on or off according to the voltage level of the node N13. For example, when the voltage level of the node N13 is greater than or equal to the critical voltage level of the voltage stabilizing element ZD1, the voltage stabilizing element ZD1 may be turned on, so that the voltage stabilizing element ZD1 may adjust the voltage level of the node N15 according to the voltage level of the node N13, to control the switch Q1. When the voltage level of the node N13 is lower than the critical voltage level of the voltage stabilizing element ZD1, the voltage stabilizing element ZD1 may be turned off, so that the voltage level of the node N13 does not affect the voltage level of the node N15. In some embodiments, the critical voltage level of the voltage stabilizing element ZD1 may correspond to a voltage level suitable for the load device 120. For example, the critical voltage level may be 125 volts.

In some embodiments, the voltage stabilizing element ZD1 may be implemented by a Zener diode. In these above embodiments, the anode of the voltage stabilizing element ZD1 may be coupled with the capacitor C1, and the cathode of the voltage stabilizing element ZD1 is coupled with the node N13.

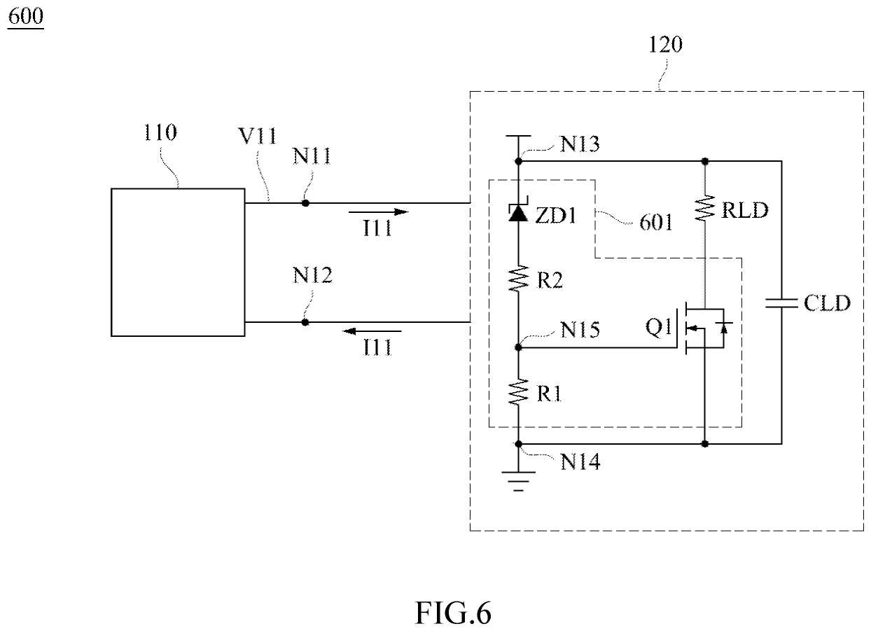

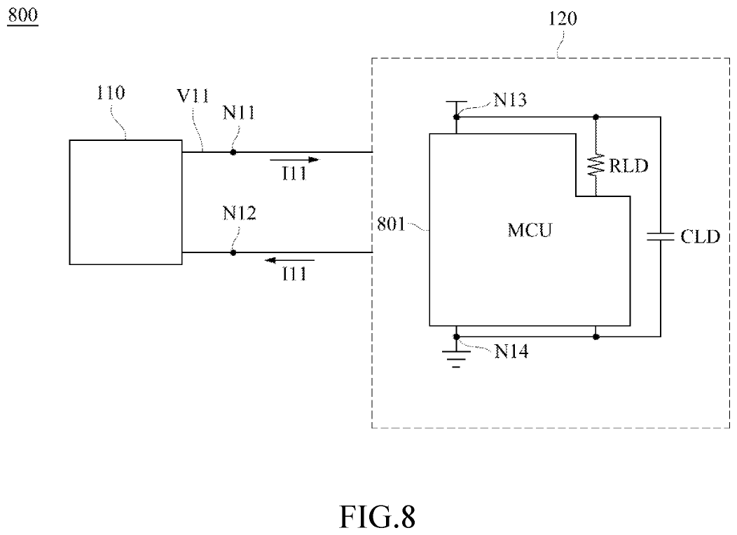

The configuration shown in FIG. 1 corresponds to a kind of embodiment of the voltage detection circuit 122. In some other embodiments, the voltage detection circuit 122 may have various other configurations, such as the configurations shown in FIG. 6 and FIG. 8.

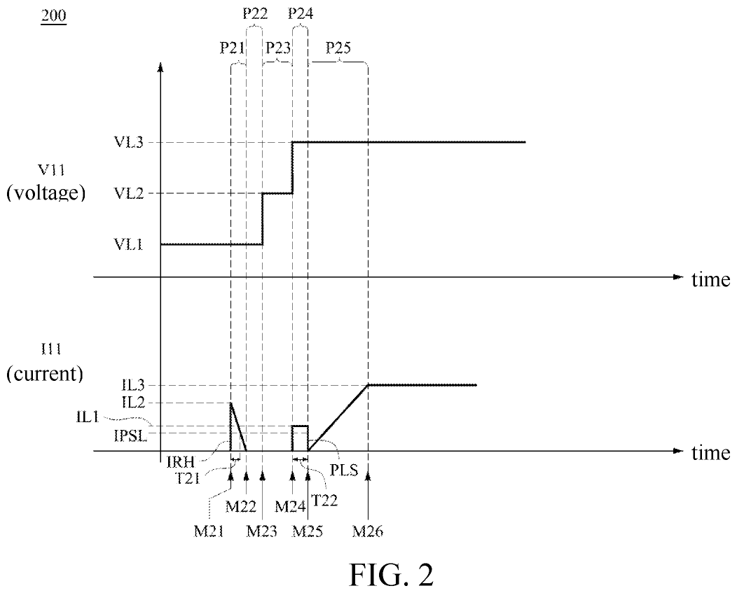

FIG. 2 is a timing diagram 200 illustrating the operation of the voltage control system 100 shown in FIG. 1 according to one or more embodiments of the present disclosure. As shown in FIG. 2, the timing diagram 200 comprises periods P21-P25 arranged in order and continuously. The period P21 starts at time point M21 and ends at the time point M22. The period P22 starts at the time point M22 and ends at the time point M23. The period P23 starts at the time point M23 and ends at the time point M24. The period P24 starts at the time point M24 and ends at the time point M25. The period P25 starts at the time point M25 and ends at the time point M26.

As shown in FIG. 2, during the periods P21-P25, the power supply device 110 may gradually adjust the voltage signal V11 from the voltage level VL1 (e.g., 12 volts) to the voltage level VL3 (e.g., 125 volts). The load device 120 may alter the current signal I11 according to the voltage signal V11. During the period P21, the current signal I11 may comprise an inrush current IRH. During the period P24, the current signal I11 may comprise a pulse current PLS.

Before the time point M21, the current signal I11 may have a zero current level, and the voltage signal V11 may have a voltage level VL1.

Referring to FIG. 1 and FIG. 2, the power supply device 110 may be coupled with the load device 120 to charge the load capacitor CLD by the voltage signal V11 at the time point M21, so that the voltage level at the node N13 is raised to the voltage level VL1. At this time, the load capacitor CLD may raise the current signal I11 to the current level IL2 to generate an inrush current IRH in response to the voltage change of the node N13. The current level IL2 may be a current level greater than 0.5 A.

During the period P21, the current signal I11 may gradually decrease from the current level IL2 to the zero current level in response to the gradual full charge of the load capacitor CLD, and the voltage signal V11 may have a voltage level VL1.

As shown in FIG. 2, during the duration of time T21 starting from the time point M21, the current level of the inrush current IRH may be greater than or equal to the predetermined current level IPSL. For example, the predetermined current level IPSL may be a current level less than or equal to 0.1 A, and the current level of the inrush current IRH may be 0.5 A. Before the duration of time T21 elapses from the time point M21, the current level of the current signal I11 may be greater than or equal to the predetermined current level IPSL. After the duration of time T21 elapses from the time point M21, the current level of the current signal I11 may be lower than the predetermined current level IPSL.

At the time point M22, the load capacitor CLD may be charged, and an open circuit may be formed, so that the current signal I11 may drop to the zero current level. During the period P22, the current signal I11 may be kept at the zero current level, and the voltage signal V11 may be kept at the voltage level VL1.

Referring to FIG. 1 and FIG. 2, the control circuit 116 may determine that the current signal I11 comprises a inrush current IRH and may generate a corresponding control signal VS1 in response to that the current level of the current signal I11 is greater than or equal to the predetermined current level IPSL and that the duration of time T21 is shorter than the predetermined duration of time TS1 during the period P21, so that the step-down circuit 114 may gradually raise the voltage signal V11 after the time point M22.

At the time point M23, the step-down circuit 114 may adjust the voltage signal V11 to the voltage level VL2 (e.g., 24 volts) in response to the inrush current IRH. During the period P23, the voltage signal V11 may be kept at the voltage level VL2, and the current signal I11 may be kept at the zero current level.

At the time point M24, the step-down circuit 114 may adjust the voltage signal V11 to the voltage level VL3 in response to the inrush current IRH. In some embodiments, the critical voltage level of the voltage stabilizing element ZD1 may be greater than the voltage level VL2 and lower than or equal to the voltage level VL3. Correspondingly, the voltage stabilizing element ZD1 may be turned on according to the voltage signal V11 having the voltage level VL3 and may charge the capacitor C1, so that the capacitor C1 may adjust the current signal I11 to a current level IL1, and the current signal I11 may flow through the resistor R1.

During the period P24, the voltage signal V11 may be kept at the voltage level VL3. The voltage stabilizing element ZD1 may continuously charge the capacitor C1 according to the voltage signal V11, so that the current signal I11 is kept at the current level IL1 to form the pulse current PLS. The period P24 may have a duration of time T22. Correspondingly, the duration of time of the pulse current PLS having the current level IL1 may be the duration of time T22. In some embodiments, the duration of time T22 and the current level IL1 may be related to the capacitance of the capacitor C1 and the resistance of the resistor R1. In some embodiments, the current level IL1 may be greater than or equal to the predetermined current level IPSL.

Please refer to FIG. 1 and FIG. 2, the control circuit 116 may determine that the current signal I11 comprises a pulse current PLS in response to that the current level of the current signal I11 is greater than or equal to the predetermined current level IPSL and that the duration of time T22 is greater than or equal to the predetermined time length TS1, and may generate a corresponding control signal VS1, so that the step-down circuit 114 stops adjusting the voltage signal V11 after the time point M25 and keeps the voltage signal V11 at the voltage level VL3.

At the time point M25, the capacitor C1 may be charged and an open circuit may be formed, so that the current signal I11 has a zero current level, and the node N15 has an enable voltage level for the switch Q1. At this time, the switch Q1 may be turned on according to the voltage level of the node N15, so that the current signal I11 flows through the switch Q1 and the load resistor RLD.

During the period P25, the voltage signal V11 may be kept at the voltage level VL3 and may charge the load capacitor CLD. As the load capacitor CLD is fully charged, the current flowing through the switch Q1 and the load resistor RLD gradually increases, making the current level of the current signal I11 gradually increase. At the time point M26, the load capacitor CLD may be charged, and an open circuit may be formed, so that the current signal I11 has a current level IL3 (e.g., 2 A). After the time point M26, the voltage signal V11 may be kept at the voltage level VL3, and the current signal I11 may be kept at the current level IL3.

In some methods, in order to allow the power supply end to provide an ideal voltage to the equipment end, it is necessary to deploy a communication chip on both the power supply end and the equipment end, so that the power supply end and the equipment end can communicate with each other, which therefore increases the cost. In addition, it is necessary to configure a dedicated power and dedicated signal transmission lines for the communication chip, which is not conducive to the use of industrial products.

Compared with the above methods, in the embodiment of the present disclosure, the voltage detection circuit 122 in the load device 120 may generate the current signal I11 according to the voltage signal V11, and the power supply device 110 may adjust the voltage signal V11 according to the current signal I11. In this way, the power supply device 110 may also adjust the voltage signal V11 to the voltage level VL3 suitable for the load device 120 without adding a communication chip, which reduces the cost and facilitates the use of industrial products. In addition, when the capacitor C1 forms an open circuit, it may save the power consumption of the power supply device 110, and may protect the load device 120 when the voltage level of the node N13 is too high.

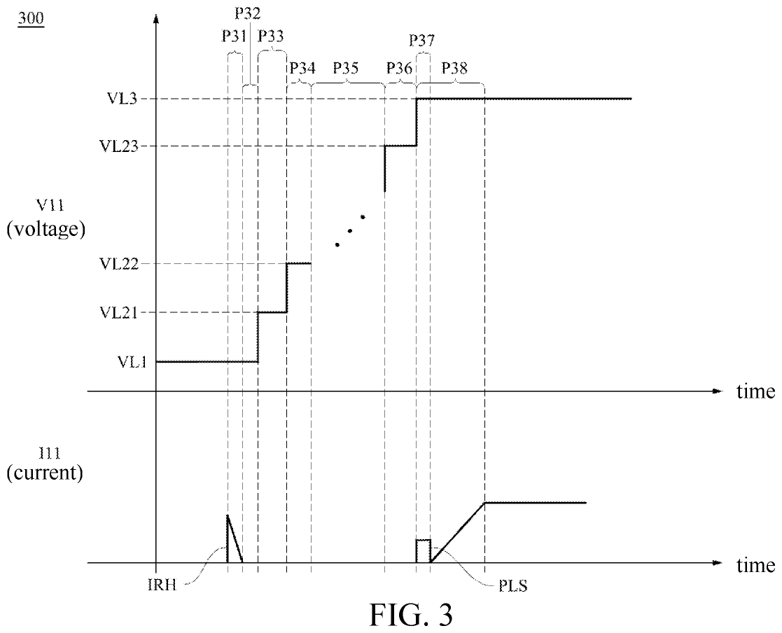

FIG. 3 is a timing diagram 300 illustrating another operation of the voltage control system 100 shown in FIG. 1 according to one or more embodiments of the present disclosure. As shown in FIG. 3, the timing diagram 300 may comprise periods P31-P38 arranged in order and continuously.

Please refer to FIG. 1 and FIG. 3, during the periods P32-P33, the step-down circuit 114 may raise the voltage signal V11 from the voltage level VL1 to the voltage level VL21 in response to that the inrush current IRH is measured by the control circuit 116 during the period P31, and may continue to raise the voltage signal V11 during the periods P34-P36 after the period P33.

During the period P33, the current signal I11 may be kept at the zero current level. During the periods P33-P34, the step-down circuit 114 may raise the voltage signal V11 from the voltage level VL21 to the voltage level VL22 in response to that the pulse current PLS of the current signal I11 has not been measured by the control circuit 116 yet.

During the periods P34-P35, the current signal I11 may be kept at the zero current level. During the periods P34-P36, the step-down circuit 114 may gradually raise the voltage signal V11 from the voltage level VL22 to the voltage level VL23 through one or more voltage levels in response to that the pulse current PLS has not been measured by the control circuit 116 yet.

During the period P36, the current signal I11 may be kept at the zero current level. During the periods P36-P37, the step-down circuit 114 may raise the voltage signal V11 from the voltage level VL23 to the voltage level VL3 in response to that the pulse current PLS has not been measured by the control circuit 116 yet.

During the period P37, the load device 120 may generate the pulse current PLS in response to that the voltage signal V11 has a voltage level VL3, and the step-down circuit 114 may stop raising the voltage signal V11 in response to that the pulse current PLS is measured by the control circuit 116. The voltage signal V11 may be kept at the voltage level VL3. In some embodiments, the critical voltage level of the voltage stabilizing element ZD1 may be greater than the voltage level VL23 and lower than or equal to the voltage level VL3.

Please refer to FIG. 2 and FIG. 3, the timing diagram 300 is a variation of the timing diagram 200. The operations of the periods P31-P33 and P37-P38 may correspond to the operations of the periods P21-P25, respectively. The voltage levels VL21-VL23 may correspond to the voltage level VL2. Therefore, some of the details regarding these periods will not be repeated herein.

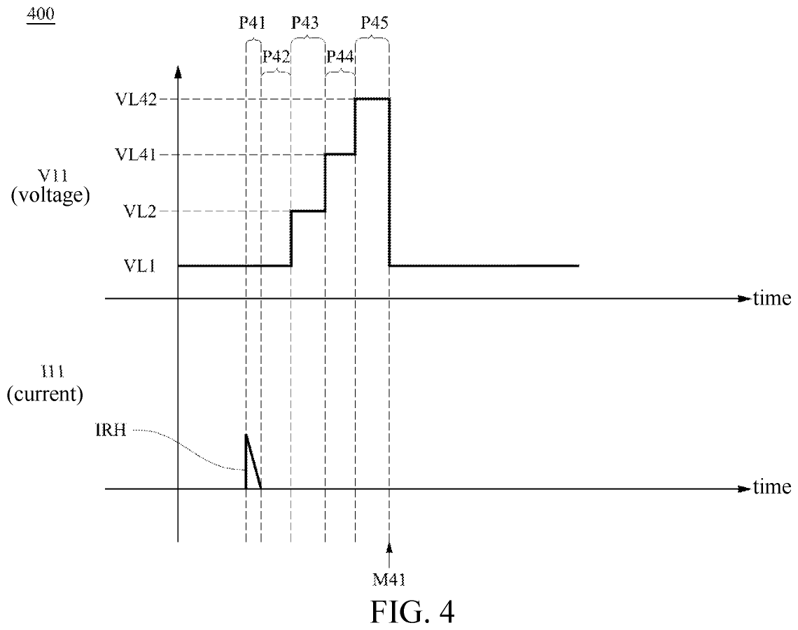

FIG. 4 is a timing diagram 400 illustrating another operation of the voltage control system 100 shown in FIG. 1 according to one or more embodiments of the present disclosure. As shown in FIG. 4, the timing diagram 400 comprises periods P41-P45 arranged in order and continuously. The period P45 ends at time point M41.

Please refer to FIG. 1 and FIG. 4, during the periods P42-P43, the step-down circuit 114 may raise the voltage signal V11 from the voltage level VL1 to the voltage level VL2 in response to that the inrush current IRH is measured by the control circuit 116 during the period P41, and may continue to raise the voltage signal V11 during the periods P43-P45 after the period P42.

During the period P43, the current signal I11 may be kept at the zero current level. During the periods P43-P44, the step-down circuit 114 may raise the voltage signal V11 from the voltage level VL2 to the voltage level VL41 in response to that the pulse current PLS has not been measured by the control circuit 116 yet.

During the period P44, the current signal I11 may be kept at the zero current level. During the periods P44-P45, the step-down circuit 114 may raise the voltage signal V11 from the voltage level VL41 to the voltage level VL42 in response to that the pulse current PLS has not been measured by the control circuit 116 yet.

In some embodiments, the voltage level VL42 may correspond to the maximum voltage level that the power supply device 110 can provide, and the voltage level VL42 may be lower than the critical voltage level of the voltage stabilizing element ZD1. Correspondingly, during the period P45, the voltage detection circuit 122 does not generate the pulse current PLS, and the current signal I11 may be kept at the zero current level.

At the time point M41, the step-down circuit 114 may reduce a voltage level of the voltage signal V11 from the voltage level VL42 to the voltage Level VL1 in response to that the control circuit 116 has not measured the pulse current PLS and that the voltage level VL42 is approximately equal to the maximum voltage level of the power supply device 110. After the time point M41, the voltage signal V11 may be kept at the voltage level VL1, and the current signal I11 may be kept at the zero current level. In this way, the power consumption of the power supply device 110 may be reduced, and the load device 120 may be protected.

Please refer to FIG. 2 and FIG. 4, the timing diagram 400 is a variation of the timing diagram 200. The operations of the periods P41-P43 may correspond to the operations of the periods P21-P23, respectively. Therefore, some of the details regarding these periods will not be repeated herein.

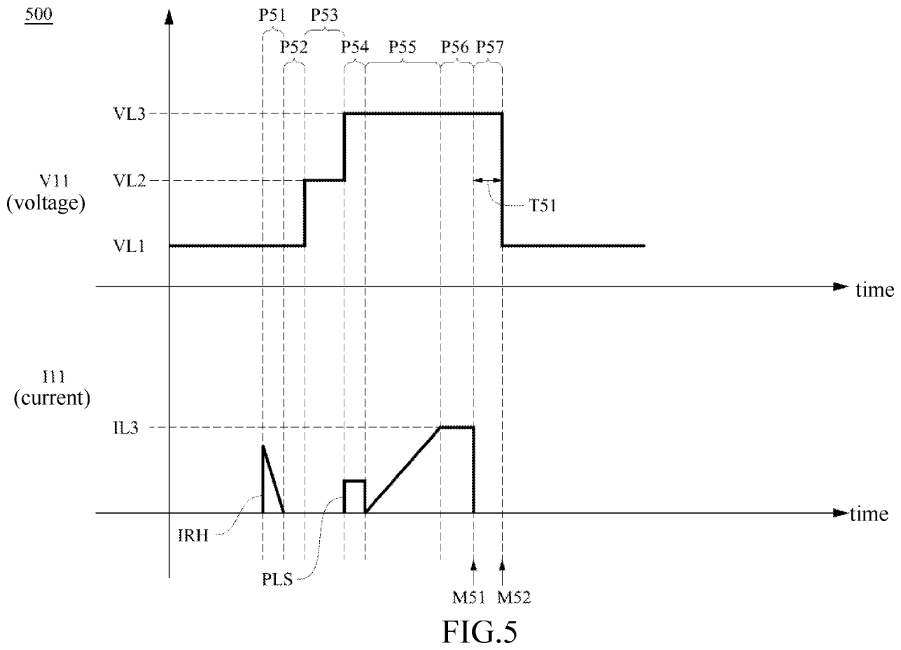

FIG. 5 is a timing diagram 500 illustrating another operation of the voltage control system 100 shown in FIG. 1 according to one or more embodiments of the present disclosure. As shown in FIG. 5, the timing diagram 500 comprises periods P51-P57 arranged in order and continuously. The period P56 ends at time point M51. The period P57 starts at the time point M51 and ends at time point M52, and has a duration of time T51.

Please refer to FIG. 2 and FIG. 5, the timing diagram 500 is a variation of the timing diagram 200. The operations in the periods P51-P55 may correspond to the operations in the periods P21-P25, respectively. Therefore, some of the details regarding these periods will not be repeated herein.

During the period P56, the voltage signal V11 may be kept at the voltage level VL3, and the current signal I11 may be kept at the current level IL3. At the time point M51, the current level of the current signal I11 may decrease from the current level IL3 to the zero current level. During the period P57, the voltage signal V11 may be kept at the voltage level VL3, and the current signal I11 may be kept at the zero current level. Correspondingly, the control circuit 116 may detect that the current signal I11 is kept at the zero current level during the period P57. The period P57 has the duration of time T51.

Please refer to FIG. 5 and FIG. 1, in some embodiments, at the time point M51, the load device 120 may be disconnected from the power supply device 110. In other words, the node N11 may be disconnected from the node N13. Correspondingly, the voltage level of the node N13 may decrease to the ground voltage level, so that the current signal I11 decreases to the zero current level.

At the time point M52, the step-down circuit 114 may adjust the voltage signal V11 from the voltage level VL3 to the voltage level VL1 in response to the control circuit 116 detecting that the duration of time T51 of the current signal I11 having a zero current level is greater than or equal to the predetermined duration of time TS2. After the time point M52, the voltage signal V11 may be kept at the voltage level VL1, and the current signal I11 may be kept at the zero current level. In this way, the voltage control system 100 may reduce the voltage level of the voltage signal V11 to reduce power consumption when the load device 120 is disconnected from the power supply device 110.

FIG. 6 is a schematic diagram illustrating a voltage control system 600 according to one or more embodiments of the present disclosure. Please refer to FIG. 1 and FIG. 6, the voltage control system 600 is a variation of the voltage control system 100. Some elements of the voltage control system 600 adopt the same reference numerals with those of the voltage control system 100. For brevity, the discussion will focus on how the voltage control system 600 differs from the voltage control system 100 rather than where it is the same.

Please refer to FIG. 1 and FIG. 6, compared with the voltage control system 100, the voltage control system 600 may comprise a voltage detection circuit 601 instead of the voltage detection circuit 122. The voltage detection circuit 601 may comprise a resistor R2 instead of the capacitor C1. A first end of the resistor R2 may be coupled with the voltage stabilizing element ZD1, and a second end of the resistor R2 may be coupled with the node N15.

Please refer to FIG. 2 to FIG. 6, in various embodiments, the voltage control system 600 may perform operations similar to those shown in the timing diagrams 200, 300, 400, and/or 500.

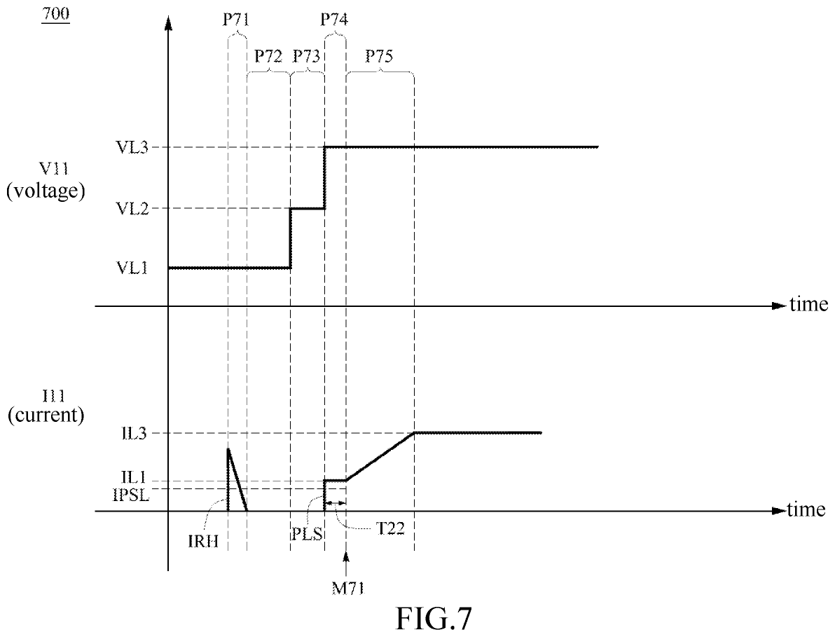

FIG. 7 is a timing diagram 700 illustrating the operation of the voltage control system 600 shown in FIG. 6 according to one or more embodiments of the present disclosure. As shown in FIG. 7, the timing diagram 700 comprises periods P71-P75 arranged in order and continuously. The period P74 ends at time point M71. The period P75 starts at the time point M71. Please refer to FIG. 2 and FIG. 7, the operations during the periods P71-P75 and the time point M71 are similar to the operations during the periods P21-P25 and the time point M25, respectively. Therefore, similar descriptions related to these periods and time points will not be repeated herein.

During the period P74, the voltage signal V11 may have the voltage level VL3, so that the voltage stabilizing element ZD1 is turned on. Correspondingly, the current signal I11 may flow through the voltage stabilizing element ZD1 and the resistors R2 and R1, and the current signal I11 may have a current level IL1 and may be kept at the current level IL1 during the duration of time T22 to form a pulse current PLS. The control circuit 116 may determine that the current signal I11 has a pulse current PLS in response to that the current level of the current signal I11 is greater than or equal to the predetermined current level IPSL and that the duration of time T22 is greater than or equal to the predetermined duration of time TS1. The step-down circuit 114 may stop adjusting the voltage signal V11 and keep the voltage signal V11 at the voltage level VL3 in response to that the pulse current PLS is measured by the control circuit 116 after the period P74.

During the period P75, the voltage signal V11 may be kept at the voltage level VL3 and may charge the load capacitor CLD. As the load capacitor CLD is fully charged, the current signal I11 may gradually increase from the current level IL1 to the current level IL3. After the period P75, the current signal I11 may be kept at the current level IL3, and the voltage signal V11 may be kept at the voltage level VL3.

FIG. 8 is a schematic diagram illustrating a voltage control system 800 according to one or more embodiments of the present disclosure. Please refer to FIG. 1 and FIG. 8, the voltage control system 800 is a variation of the voltage control system 100. Some elements of the voltage control system 800 adopt the same reference numerals with those of the voltage control system 100. For brevity, the discussion will focus on how voltage control system 800 differs from voltage control system 100 rather than where it is the same.

Please refer to FIG. 1 and FIG. 8, compared with the voltage control system 100, the voltage control system 800 may comprise a voltage detection circuit 801 instead of the voltage detection circuit 122. The voltage detection circuit 801 may be implemented by a digital circuit, such as an MCU. The voltage detection circuit 801 may be coupled between the nodes N13 and N14. The load resistor RLD may be coupled between the node N13 and the voltage detection circuit 801.

Please refer to FIG. 2 to FIG. 8, in various embodiments, the voltage detection circuit 801 may generate the current signal I11 according to the voltage level of the node N13, so as to perform operations similar to those shown in the timing diagrams 200, 300, 400, and/or 500.

Although the present disclosure has been described above with the embodiments, those embodiments are not intended to limit the present disclosure. Any person with ordinary skills in the art may make changes and modifications without departing from the spirit and scope of the present disclosure. Therefore, the protection scope of the present disclosure should be defined by the scope of the appended claims.

1. A voltage control system, comprising:
a load device, being configured to generate a current signal according to a voltage signal; and
a power supply device, being configured to:
provide the voltage signal to the load device;
adjust the voltage signal in response to an inrush current of the current signal; and
stop adjusting the voltage signal in response to a pulse current of the current signal.

2. The voltage control system according to claim 1, wherein the power supply device is further configured to:
determine that the current signal comprises the inrush current and start to raise the voltage signal when a current level of the current signal has been greater than or equal to a predetermined current level for a first duration of time; and
determine that the current signal comprises the pulse current and stop raising the voltage signal when the current level of the current signal has been greater than or equal to the predetermined current level for a second duration of time;
wherein the first duration of time is less than a predetermined duration of time, and the second duration of time is greater than or equal to the predetermined duration of time.

3. The voltage control system according to claim 2, wherein:
the load device is configured to raise the current signal to generate the inrush current at a first time point;
the current level of the current signal gradually decreases after the first time point; and
the current level of the current signal is lower than the predetermined current level after the first duration of time elapsed from the first time point.

4. The voltage control system according to claim 1, wherein:
the load device is further configured to generate, in response to that the power supply device is coupled with the load device, the inrush current during a first period;
the power supply device is further configured to raise, in response to the inrush current, the voltage signal during a second period after the first period;
the load device is further configured to generate, in response to that a voltage level of the voltage signal is greater than or equal to a critical voltage level of the load device, the pulse current during a third period after the second period; and
the power supply device is further configured to maintain, in response to the pulse current, the voltage level of the voltage signal after the third period.

5. The voltage control system according to claim 4, wherein:
the power supply device is further configured to reduce, in response to determining that the current signal comprises a first current level, the voltage level of the voltage signal after the third period; and
the current signal has the first current level during the second period.

6. The voltage control system according to claim 4, wherein the load device comprises:
a switch, being configured to generate the current signal according to the voltage signal; and
a voltage stabilizing element, being configured to turn off when the voltage level of the voltage signal is lower than the critical voltage level, and configured to turn on when the voltage level of the voltage signal is greater than or equal to the critical voltage level, to turn on the switch.

7. The voltage control system according to claim 1, wherein:
the current signal comprises the inrush current, and the voltage signal has a first voltage level, during a first period;
the current signal has a first current level, and the voltage signal has a second voltage level greater than the first voltage level, during a second period after the first period; and
the current signal has a second current level greater than the first current level, and the voltage signal has a third voltage level greater than the second voltage level, during a third period after the second period.

8. The voltage control system according to claim 7, wherein:
the current signal has the first current level, and the voltage signal has the third voltage level, during a fourth period after the third period; and
the power supply device is further configured to adjust, in response to that a duration of time of the fourth period is greater than or equal to a predetermined time length, the voltage signal to the first voltage level.

9. The voltage control system according to claim 1, wherein:
the power supply device is further configured to raise the voltage signal from a first voltage level in response to the inrush current;
the current signal is kept at a first current level in response to that a voltage level of the voltage signal is lower than a critical voltage level of the load device; and
the power supply device is further configured to reduce a voltage level of the voltage signal to the first voltage level in response to that the voltage level of the voltage signal is equal to a maximum voltage level of the power supply device and that the current signal has the first current level.

10. The voltage control system according to claim 1, wherein the load device comprises:
a load resistor;
a load capacitor;
a switch, wherein a first end of the switch is coupled with a first end of the load resistor, and a second end of the switch is coupled with a first end of the load capacitor at a first node;
a voltage stabilizing element, being coupled with a second end of the load resistor at a second node and configured to:
turn off in response to that a voltage level of the second node is lower than a critical voltage level; and
turn on in response to that the voltage level of the second node is greater than or equal to the critical voltage level to; and
another capacitor, being coupled between the voltage stabilizing element and a control end of the switch,
wherein the power supply device is further configured to provide the voltage signal to the second node and receive the current signal from the first node.

11. A power supply device for voltage control, comprising a power supply circuit, a control circuit, and a step-down circuit coupled with the power supply circuit and the control circuit, wherein:
the power supply circuit is configured to provide a first voltage signal to the step-down circuit;
the step-down circuit is configured to generate a second voltage signal after receiving the first voltage signal;
the control circuit is configured to generate a control signal according to the second voltage signal and a current signal generated by a load device; and
the step-down circuit is further configured to adjust the second voltage signal according to the control signal and adjust the second voltage signal in response to an inrush current of the current signal and stop adjusting the second voltage signal in response to a pulse current of the current signal.

12. The power supply device according to claim 11, wherein when a current level of the current signal is greater than or equal to a predetermined current level, the step-down circuit is further configured to:
determine that the current signal comprises the inrush current and thus start to raise the voltage signal; and
determine that the current signal comprises the pulse current and thus stop raising the voltage signal when the current level of the current signal has been greater than or equal to the predetermined current level.

13. The power supply device according to claim 11, wherein the step-down circuit is further configured to:
determine that the current signal comprises the inrush current and start to raise the voltage signal when a current level of the current signal has been greater than or equal to a predetermined current level for a first duration of time; and
determine that the current signal comprises the pulse current and stop raising the voltage signal when the current level of the current signal has been greater than or equal to the predetermined current level for a second duration of time.

14. The power supply device according to claim 13, wherein the first duration of time is less than a predetermined duration of time, and the second duration of time is greater than or equal to the predetermined duration of time.

15. A load device, being coupled with a voltage control device, the load device comprising:
a load resistor;
a load capacitor; and
a voltage detection circuit, being coupled with the load resistor and the load capacitor and being configured to generate a current signal according to a voltage signal generated by a power supply device;
wherein the load capacitor is configured to generate an inrush current in response to the voltage signal.

16. The load device according to claim 15, wherein:
the load capacitor is further configured to generate a pulse current when a voltage level of the voltage signal is continuously raised and a current level of the current signal is greater than or equal to a predetermined current level; and
the inrush current and the pulse current are arranged in order.
